(19) United States
(12) Patent Application Publication
(10) Pub. No.: US 2017/0334531 A1
(43) Pub. Date: Nov. 23, 2017

(54) DIVING AND SNORKELING MASK STRUCTURE

(71) Applicant: QBAS Co., Ltd., Taipei (TW)

(72) Inventor: Chih-Cheng Shiue, Taipei (TW)

(21) Appl. No.: 15/596,172

(22) Filed: May 16, 2017

Related U.S. Application Data
(60) Provisional application No. 62/337,916, filed on May 18, 2016.
(60) Provisional application No. 62/410,896, filed on Oct. 21, 2016.
(60) Provisional application No. 62/422,121, filed on Nov. 15, 2016.

(51) Int. Cl. B63C 11/16; A62B 9/02; H04N 5/225; B63C 11/12

(52) U.S. Cl. CPC B63C 11/16; H04N 5/2253; A62B 9/02; B63C 2011/128

(57) ABSTRACT

A diving and snorkeling mask structure including a full face mask, a frame, at least one lens, a joint, a respiratory tube and at least one securing belt is disclosed. The full face mask includes a first soft material region connected with a second soft material region. The frame is combined with the second soft material region of the full face mask. The at least one lens is disposed in the frame. The joint is disposed on the full face mask, and adjacent to the upper side of the frame. The respiratory tube is disposed on the joint, and establishes the air communication with the full face mask via the joint. The at least one securing belt includes a side buckle element to snap fit the full face mask.

This application claims priority to U.S. Provisional Patent Application No. 62/337,916 filed on May 18, 2016, No. 62/410,896 filed on Oct. 21, 2016, and No. 62/422,121 filed on Nov. 15, 2016.

### CROSS-REFERENCES TO RELATED APPLICATIONS

Not applicable.

### BACKGROUND OF THE INVENTION

### Field of the Invention

The present invention relates to a mask structure, and more particularly, to a diving and snorkeling mask structure adapted to snorkeling or diving sports.

### Descriptions of the Related Art

A full face goggle mask currently available tends to cause a considerable compression pressure onto a user's face when actually being worn. Particularly when the user dives under the water, the pressure imposed onto the user's face by the full face goggle mask will increase as the underwater depth increases, thereby causing discomfort to the user.

Moreover, this kind of full face goggle masks appear to have a large area of transparent lens, but the visual range thereof is very limited during the actual use due to the special design of a frame structure thereof, which disenables the user to have a sufficient field of vision when wearing the mask underwater.

Additionally, a mask and a respiratory tube included in the full face goggle mask currently available are independently disposed components, so the mask and the respiratory tube are likely to be lost because they need to be stored or carried separately.

Accordingly, an urgent need exists in the art to provide a diving and snorkeling mask structure to improve the aforesaid drawbacks.

### SUMMARY OF THE INVENTION

An objective of the present invention is to provide a diving and snorkeling mask structure, which can improve the comfort level in use while fully covering a user's face. Another objective of the present invention is to provide a diving and snorkeling mask structure provided with an elastic head strap, which can improve the comfort level in use and facilitate the putting on and the taking off of the mask.

Yet another objective of the present invention is to provide a diving and snorkeling mask structure, a respiratory tube of which is combined with the body of the mask in a bendable manner and thus is convenient to carry.

To achieve the aforesaid objectives, a diving and snorkeling mask structure disclosed in the present invention comprises a full face mask, a frame, at least one lens, a joint, a respiratory tube and at least one securing belt. The full face mask comprises a first soft material region and a second soft material region connected with each other. The frame is combined with the second soft material region of the full face mask. The at least one lens is disposed in the frame. The joint is disposed on the full face mask and adjacent to the upper side of the frame. The respiratory tube is disposed on the joint and establishes the air communication with the full face mask via the joint. The at least one securing belt comprises a side buckle element adapted to snap fit the full face mask.

To achieve the aforesaid objectives, the soft material of the first soft material region has a hardness smaller than that of the soft material of the second soft material region in the diving and snorkeling mask structure of the present invention.

To achieve the aforesaid objectives, a total area of the first soft material region and the second soft material region is larger than a half of a viewing window area of the at least one lens in the diving and snorkeling mask structure of the present invention.

To achieve the aforesaid objectives, the first soft material region and the second soft material region are of a same material in the diving and snorkeling mask structure of the present invention.

To achieve the aforesaid objectives, the diving and snorkeling mask structure of the present invention further comprises a water draining valve disposed at a lower end of the full face mask and adjacent to the user's mouth.

To achieve the aforesaid objectives, the diving and snorkeling mask structure of the present invention further comprises a latching device, wherein the latching device has a latch and a groove engaged with each other, and the latch and the groove are disposed on the joint and the frame respectively.

To achieve the aforesaid objectives, the diving and snorkeling mask structure of the present invention further comprises an external hard frame disposed around the full face mask.

To achieve the aforesaid objectives, at least one elastic head strap is disposed on the external hard frame in the diving and snorkeling mask structure of the present invention.

To achieve the aforesaid objectives, an auxiliary device, e.g., a fixing mechanism for fixing a miniature video camera, is disposed on the external hard frame in the diving and snorkeling mask structure of the present invention.

To achieve the aforesaid objectives, the side buckle element in the diving and snorkeling mask structure of the present invention snap fits the full face mask in the form of a quick-release buckle.

To achieve the aforesaid objectives, the elastic head strap of the diving and snorkeling mask structure of the present invention has at least one latch.

To achieve the aforesaid objectives, the diving and snorkeling mask structure of the present invention further comprises a top cover which is disposed on the respiratory tube and having a protrusion; the respiratory tube further comprises a seal ring, and the protrusion may abut against the seal ring.

To achieve the aforesaid objectives, the auxiliary device of the diving and snorkeling mask structure of the present invention is provided with a miniature video camera.

Accordingly, the diving and snorkeling mask structure of the present invention at least can provide the following benefits: the goggle mask made of soft materials is convenient to carry and improves the comfort level in use; the design of the viewing window with a large area can increase the field of vision of the user; the arrangement of the latching device can prevent the respiratory tube from being bent due to the pressure during the diving; the design of the external hard frame can stabilize the diving and snorkeling mask structure; and the design of the elastic head strap can stabilize the diving and snorkeling mask structure and facilitate the putting on and the taking off of the diving and snorkeling mask structure.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a diving and snorkeling mask structure according to a first embodiment of the present invention;

FIG. 2 is a front view of the diving and snorkeling mask structure according to the first embodiment of the present invention;

FIG. 3 is a schematic view illustrating the joining of a mask and a securing belt in the diving and snorkeling mask structure according to the first embodiment of the present invention;

FIG. 4 is a schematic view illustrating a part of a face-contacting area of the mask in the diving and snorkeling mask structure according to the first embodiment of the present invention;

FIG. 5A is a simplified schematic view of the diving and snorkeling mask structure according to the first embodiment of the present invention when being viewed from the back side;

FIG. 5B is a cross-sectional view of the diving and snorkeling mask structure of FIG. 5A;

FIG. 6A and FIG. 6B are schematic views illustrating how to achieve ear pressure balance by using the diving and snorkeling mask structure according to the first embodiment of the present invention;

FIG. 7 is a schematic view of a latching device of the diving and snorkeling mask structure according to the first embodiment of the present invention;

FIG. 8 is a schematic view of the latching device of the diving and snorkeling mask structure according to the first embodiment of the present invention in a bent status;

FIG. 9 is a schematic view illustrating a respiratory tube, in the diving and snorkeling mask structure according to the first embodiment of the present invention, that is connected to a lens via a joint in the form of a hose and in a bent status;

FIG. 10A is a schematic view illustrating an end of the respiratory tube in the diving and snorkeling mask structure according to the first embodiment of the present invention;

FIG. 10B is a schematic view illustrating the end of the respiratory tube in an air-tight status in the diving and snorkeling mask structure according to the first embodiment of the present invention;

FIG. 11 is a front view of a diving and snorkeling mask structure according to a second embodiment of the present invention;

FIG. 12 is a schematic view of the diving and snorkeling mask structure according to the second embodiment of the present invention;

FIG. 13A is a schematic view illustrating a securing belt (an elastic head strap) engaged with a full face mask in the diving and snorkeling mask structure according to the second embodiment of the present invention;

FIG. 13B is a schematic view of the securing belt (the elastic head strap) of the diving and snorkeling mask structure according to the second embodiment of the present invention;

FIG. 14 is a front view of a diving and snorkeling mask structure according to a third embodiment of the present invention;

FIG. 15 is a rear view of the diving and snorkeling mask structure according to the third embodiment of the present invention;

FIG. 16 is an exploded view of the diving and snorkeling mask structure according to the third embodiment of the present invention;

FIG. 17 is a partial combined view of the diving and snorkeling mask structure according to the third embodiment of the present invention;

FIG. 18 is a schematic view of the diving and snorkeling mask structure according to the third embodiment of the present invention; and

FIG. 19 is a bottom view of FIG. 18.

### DESCRIPTION OF THE PREFERRED EMBODIMENT

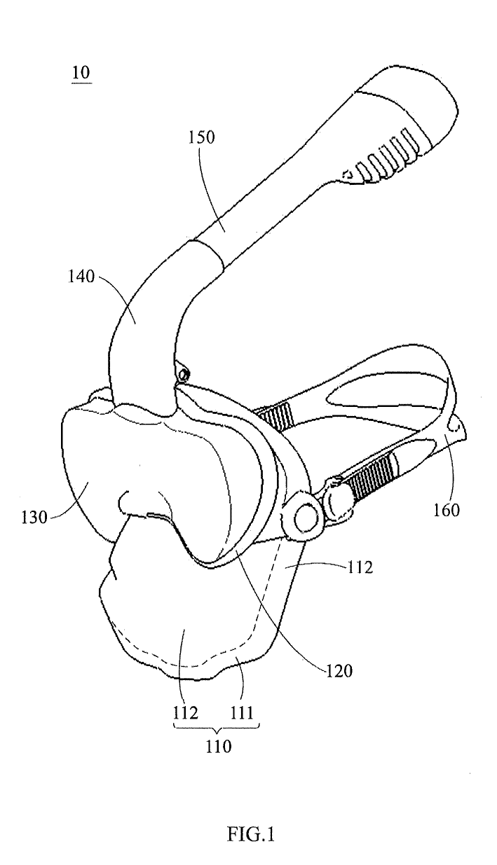

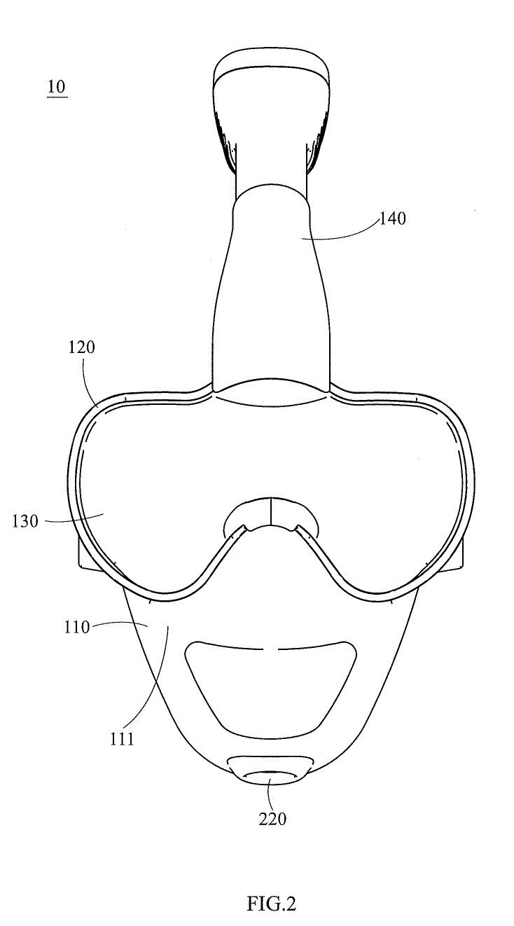

As shown in FIG. 1 and FIG. 2, a diving and snorkeling mask structure 10 of the present invention is adapted to be worn on a user's head during a diving sport for performing underwater activities. The diving and snorkeling mask structure 10 may structurally comprise a full face mask 110, a frame 120, a lens 130, a joint 140, a respiratory tube 150 and a securing belt 160, and technical contents of these elements are as follows.

First, the full face mask 110 of the present invention is of a complete soft material design, and it consists of a first soft region 111 and a second soft region 112 connected with each other. The first soft material region 111 is a part of the full face mask 110 that makes contact with the user's face when the mask is being worn, and the second soft material region 112 is the remaining part of the full face mask 110 that does not make contact with the user's face. The frame 120 is combined with the first soft material region 111 of the full face mask 110. The lens 130 may be made of a transparent thermoplastic, or glass, or glass overmolded by a thermoplastic, and it is disposed in the frame 120 by assembling or overmolding. The lens 130 is surrounded by the frame 120 in appearance.

It shall be appreciated that, in the embodiment shown in FIG. 1 and FIG. 2, the lens 130 is a single lens, but it is not limited thereto. In other words, the lens 130 may also be two lenses; and in case of two lenses, a corrective lens may be used in combination with the lens 130 depending on the user's needs to satisfy special requirements of short-sighted or long-sighted users.

The joint 140 is disposed above the full face mask 110. That is, the joint 140 is disposed above the lens 130 and is in communication with the space defined by the lens 130. Because the frame 120 surrounds the lens 130, the joint 140 may also be interpreted as disposed or connected above the frame 120 in appearance. The respiratory tube 150 and the joint 140 are disposed on the lens 130 in a bendable manner, and the respiratory tube 150 is in communication with the full face mask 110 via the joint 140. That is, the respiratory tube 150 is in communication with the space defined by the lens 130 via the joint 140 to achieve the purpose of air communication.

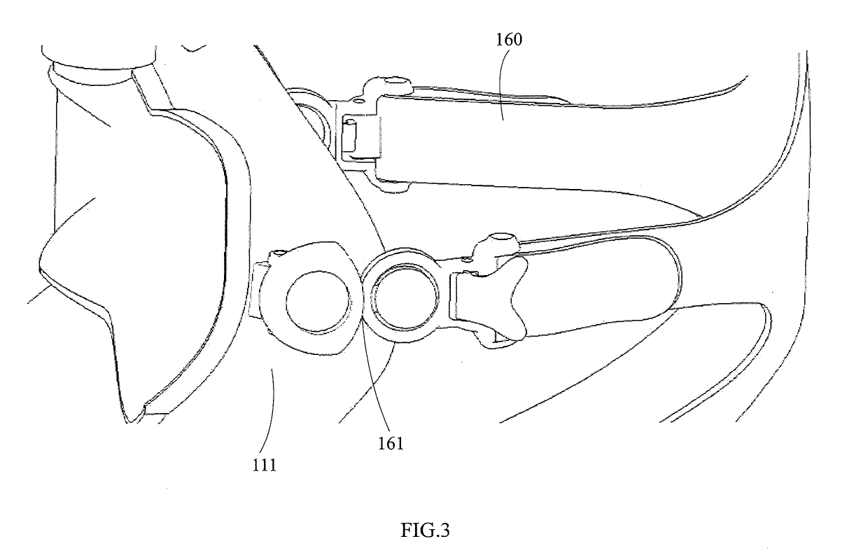

FIG. 3 is a schematic view illustrating the joining of the full face mask 110 and the securing belt 160 in the diving and snorkeling mask structure 10 according to the present invention. The securing belt 160 comprises a side buckle element 161, and in this embodiment, the securing belt 160 snap fits the first soft material region 111 of the full face mask 110 via the side buckle element 161 in the form of a quick-release buckle so as to be worn on the user's head. Apart from being disposed on the full face mask 110, the aforesaid side buckle element 161 may also be installed on the frame 120.

Apart from joining through the quick-release buckle as described in this embodiment, the securing belt 160 may also be joined to the full face mask 110 via other buckling manners, and no limitation is made thereto. Additionally, the side buckle element 161 of this embodiment is circular, but the side buckle element 161 may also be of any other shape, e.g., a rectangle, a triangle or the like, in other embodiments, and no limitation is made thereto.

What described above is the relative positional distribution among the main elements of the diving and snorkeling mask structure 10, and detailed technical contents of the elements will be described in detail hereinafter.

The first soft material region 111 is the region that makes contact with the user's face when the diving and snorkeling mask structure 10 is being worn, and the second soft-material region 112 is disposed on the other side opposite to the user's cheek where structures such as the frame 120, the lens 130, and the securing belt 160 are to be installed. In this embodiment, a soft material used for the first soft-material region 111 is relatively softer, while a soft material used for the second soft-material region 112 is relatively harder. Preferably, the soft material of the first soft material region 111 has a hardness of Shore A 30˜60, while the soft material of the second soft material region 112 has a hardness of Shore A 60˜90.

Moreover, although the first soft material region 111 and the second soft material region 112 of this embodiment are made of different soft materials and have different hardness, the first soft material region 111 and the second soft material region 112 may also be made of the same material having the same hardness in the present invention, and a comfortable wearing experience is provided for the user by varying the thickness of the two soft material regions (e.g., by making the first soft material region 111 thinner than the second soft material region 112).

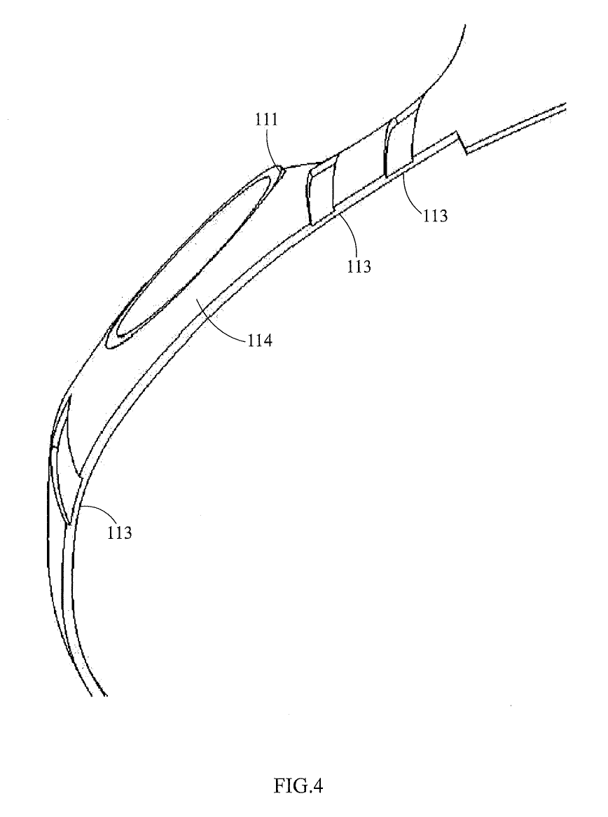

FIG. 4 is a schematic view illustrating a part of a face-contacting area of the full face mask 110 in the diving and snorkeling mask structure 10 according to the present invention. In the aspect shown in FIG. 4, in order to have the first soft material region 111 of the full face mask 110 adapt to different face profiles and thus provide a tight-fit effect when the full face mask 110 is being worn, thickness of the first soft material may be varied at specific locations to improve ductility thereof so that the user's face can be fully covered. For example, the first soft material has a thickness of about 0.3 mm to 1.5 mm at a thin section 113 thereof and has a thickness of about 1 mm to 3 mm at a thick section 114 thereof.

In other words, both the hardness and thickness of the soft materials of the full face mask 110 in the present invention can be adjusted depending on practical needs so as to make the face-contacting first soft material region 111 soft and the second soft material region 112 at the mouth and nose areas harder for purpose of support, or thickness of a same material is varied to make the full face mask 110 tightly fit against the user's face profile.

The soft material used in the full face mask 110 may be of different soft materials, or are formed of soft materials having different hardness through overmolding or extrusion.

Areas of the full face mask 110 according to the present invention except for the area where the lens 130 is disposed are all formed of soft materials (i.e., the first soft material region 111 and the second soft material region 112), and the total area of the soft materials of the full face mask 110 accounts for more than a half of the area of the viewing window formed by the lens 130. In this way, the soft material having a softer sense of touch relative to the lens 130 prevent the user from discomfort when the water pressure impacts on the mask, so the comfort level in use can be improved. Meanwhile, the design of making the full face mask 110 have a large area of soft material can also make it convenient for the user to bend and store the mask.

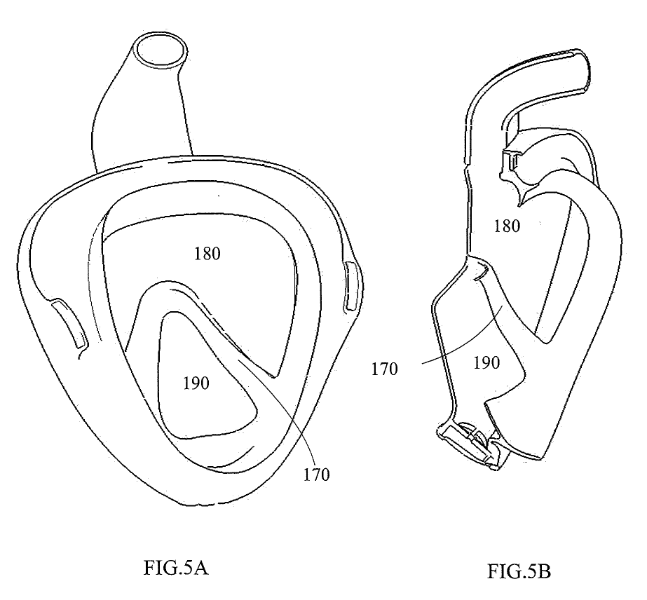

FIG. 5A is a simplified schematic view of the diving and snorkeling mask structure 10 according to the first embodiment of the present invention when being viewed from the back side, and FIG. 5B is a cross-sectional view of the diving and snorkeling mask structure of FIG. 5A. In the present invention, when the full face mask 110 is being worn by the user, a viewing region 180 and a breathing region 190 can be defined between the full face mask and the user's cheek by a nasal bridge portion 170 of the full face mask 110 that extends towards the user's face. The viewing region 180 is located above the nasal bridge portion 170, and the breathing region 190 is located below the nasal bridge portion 170.

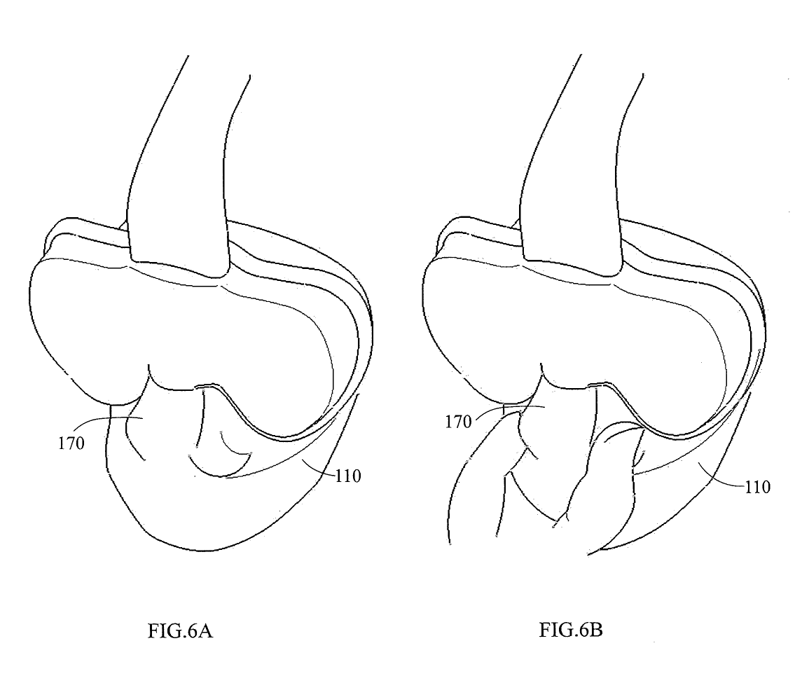

Further, as shown in FIG. 6A and FIG. 6B, with the complete soft material design of the full face mask 110 according to the present invention, the user in a diving sport can pinch the nasal bridge portion 170 through the soft full face mask 110 and perform an air blowing action to achieve an ear pressure balance. In contrast, in case of a conventional full face diving mask, the user is unable to pinch his or her nose through the mask because the mask is of a hard material design, so the user can only perform the swallow action to slightly adjust the ear pressure during the diving, and thus the ear pressure balancing effect is poor.

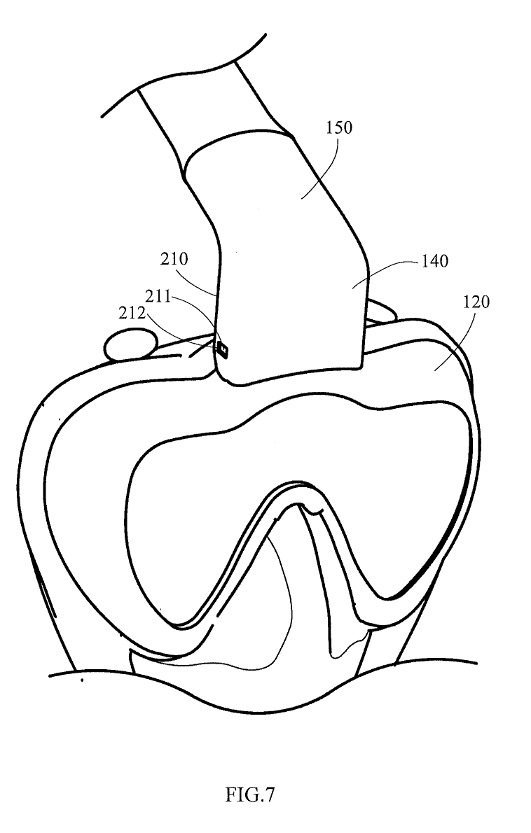

As shown in FIG. 7, the diving and snorkeling mask structure 10 of the present invention is further provided with a latching device 210. In the aspect shown in the figure, the latching device 210 has a latch 211 and a groove 212, the latch 211 is disposed at two sides of the joint 140, and the groove 212 is disposed at two sides of the frame 120 so that the latch 211 can be engaged with the groove 212. Therefore, when the latch 211 at the two sides of the joint 140 is engaged with the groove 212 at the two sides of the frame 120, the latching device 210 is in a latched status to stabilize the joining of the joint 140, the respiratory tube 150 and the full face mask 110, thereby preventing the respiratory tube 150 from being damaged due to factors such as collision, accidental push, diving pressure or the like.

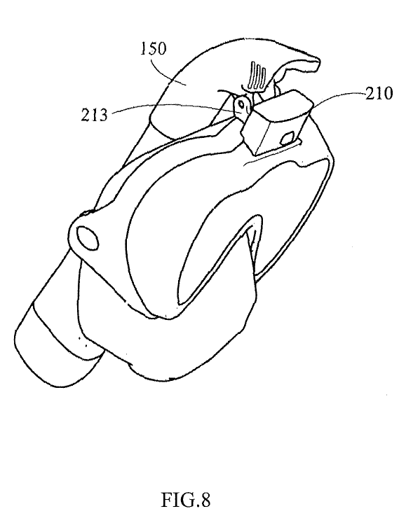

Moreover, as shown in FIG. 8, if the latching device 210 is in an unlatched status, then the respiratory tube 150 may be bent relative to the full face mask 110 via a connection element 213 so that the diving and snorkeling mask structure 10 of the present invention is easy to store. It shall be appreciated that, when the respiratory tube 150 is bent relative to the full face mask 110, a connection relationship between the respiratory tube 150 and the full face mask 110 can always be ensured due to the arrangement of the connection element 213 (i.e., the respiratory tube 150 and the full face mask 110 cannot be separated into independent elements), thereby avoiding the risk of losing the respiratory tube 150.

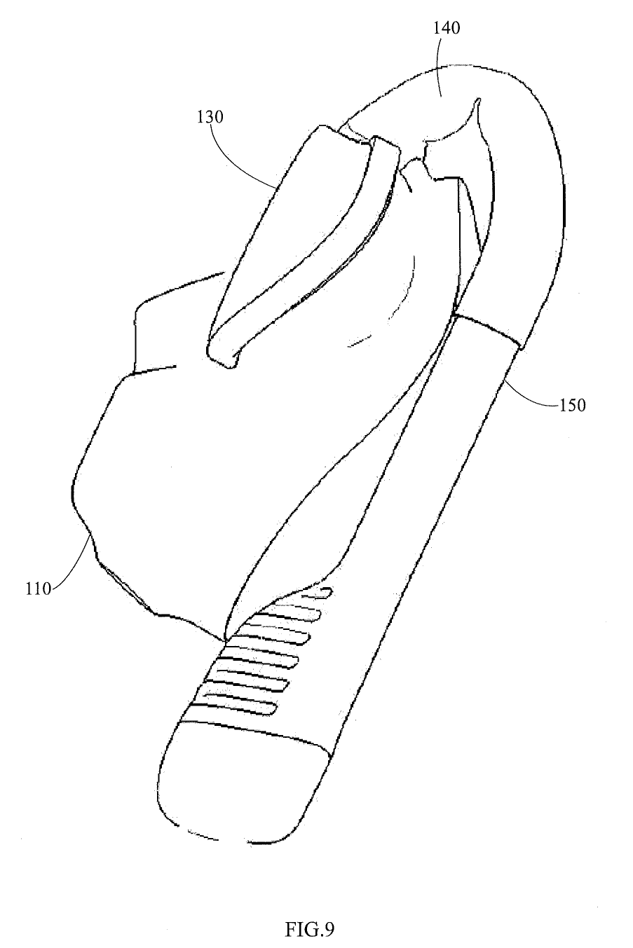

It shall be appreciated that, apart from securing and storing the respiratory tube 150 via the aforesaid latching device 210, as shown in FIG. 9, the joint 140 may also be designed into a hose and formed integrally with the soft material regions to connect the respiratory tube 150 with the lens 130, and the respiratory tube 150 is bent backwards relative to the lens 130 by means of the joint 140 in the form of a hose for the storage of the respiratory tube 150, thereby also avoiding the risk of losing the respiratory tube 150.

Referring back to FIG. 2, a water draining valve 220 may also be disposed in the full face mask 110 of the present invention and adjacent to the user's mouth.

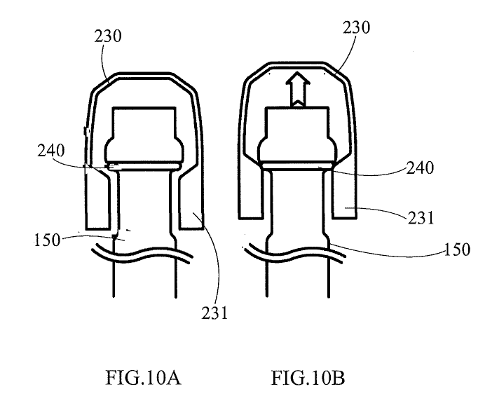

Moreover, as shown in FIG. 10A and FIG. 10B, a seal ring 240 may be disposed above the respiratory tube 150, and the seal ring 240 is covered by a top cover 230. In this way, when the user exhales and the air exhaled reaches at the top cover 230 through the respiratory tube 150, the top cover 230 will be pushed upwards and then the protrusion 231 of the top cover 230 will abut against the seal ring 240 to form an air-tight status, so the air cannot be expelled from the top cover 230 and is forced to move downwards to be expelled through the water draining valve 220, thereby draining the excess water in the mask to the outside via the water draining valve 220.

What described above are the technical contents of the first embodiment of the diving and snorkeling mask structure 10 according to the present invention, and technical contents of a diving and snorkeling mask structure 20 according to a second embodiment of the present invention will be described hereinafter. For technical features of elements in the diving and snorkeling mask structure 20 of the second embodiment that are the same as or similar to those in the diving and snorkeling mask structure 10 of the first embodiment, reference may be directly made to the descriptions of the previous paragraphs.

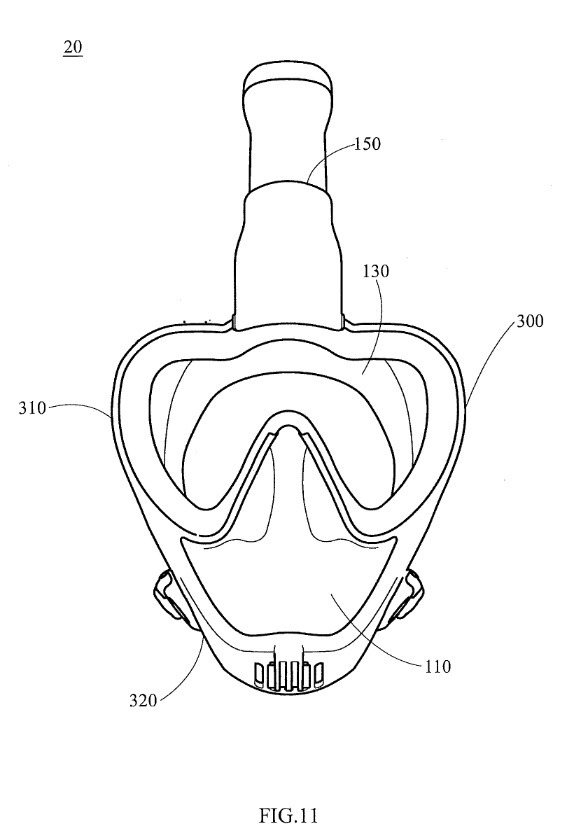

As shown in FIG. 11, the diving and snorkeling mask structure 20 of the second embodiment in the present invention mainly differs from the diving and snorkeling mask structure 10 of the first embodiment in that: the diving and snorkeling mask structure 20 further comprises an external hard frame 300; and the external hard frame 300 may be made of hard materials such as plastic or acryl and is disposed around the full face mask 110 to stabilize the full face mask 110 made of soft materials.

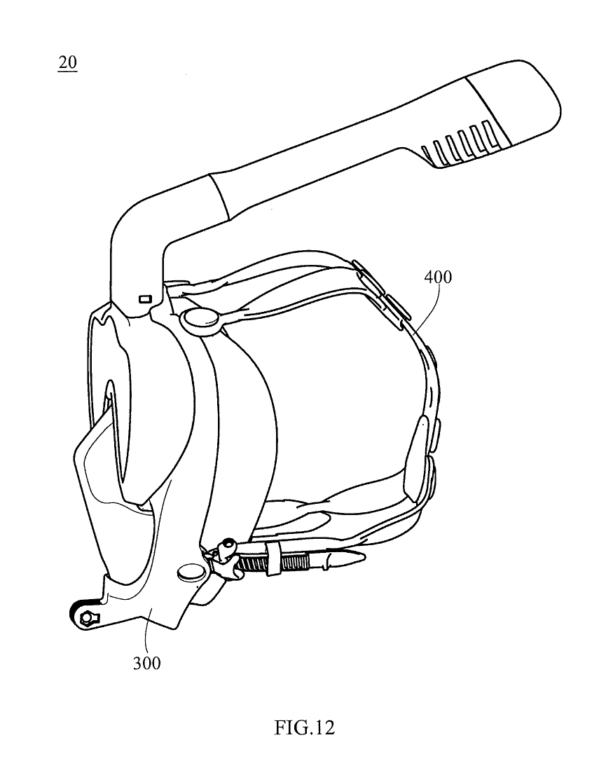

Please refer to FIG. 12, which is a schematic view of the diving and snorkeling mask structure 20 of the second embodiment when viewed from another angle. As shown in FIG. 12, an X-shaped elastic head strap 400 may be disposed at the back of the user's head and fixed to the external hard frame 300 (and it may also be fixed on the full face mask 110). In this way, through the joining between the external hard frame 300 and the X-shaped elastic head strap 400, the diving and snorkeling mask structure 20 can be more stable and is unlikely to come off when being worn.

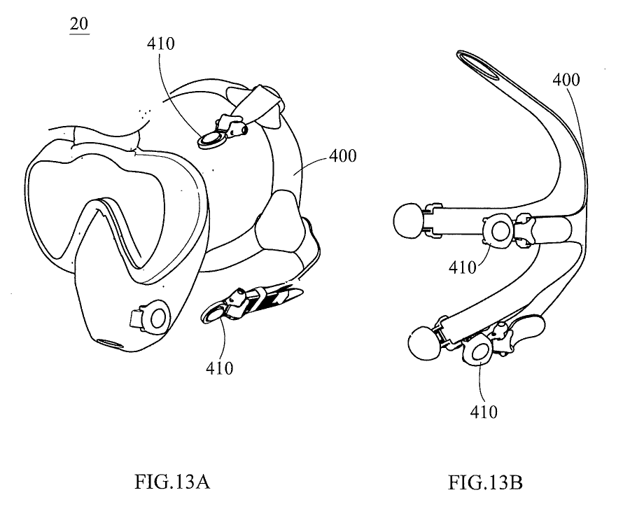

Additionally, as shown in FIG. 13A and FIG. 13B, four ends 410 of the elastic head strap 400 may also be provided as quick release buckles as in the securing belt 160 so as to be joined to the external hard frame 300 or the full face mask 110, and in this way, the diving and snorkeling mask structure 20 can be put on or taken off more quickly. Moreover, although the elastic head strap 400 is X-shaped in this embodiment, the elastic head strap 400 may also be of other shapes in other embodiments. For example, the elastic head strap 400 may have a shape of a single bar (with only two ends) as shown in FIG. 1, and no limitation is made thereto.

Technical contents of a diving and snorkeling mask structure 30 according to a third embodiment of the present invention will be described hereinafter. For technical features of elements in the diving and snorkeling mask structure 30 of the third embodiment that are the same as or similar to those in the diving and snorkeling mask structures 10 and 20 of the first and the second embodiments, reference may be directly made to the descriptions of the previous paragraphs.

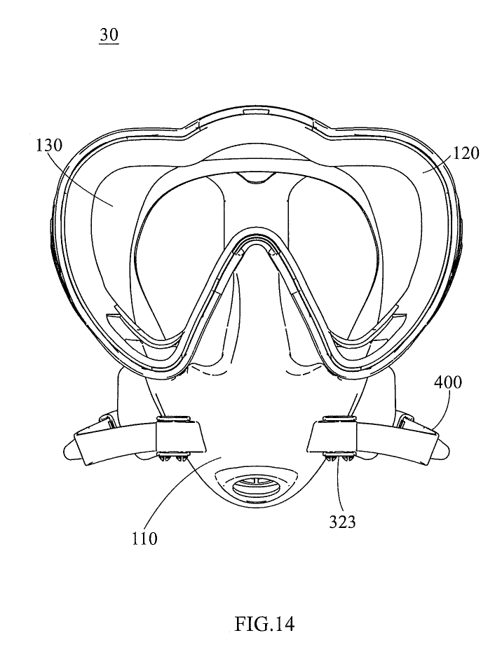

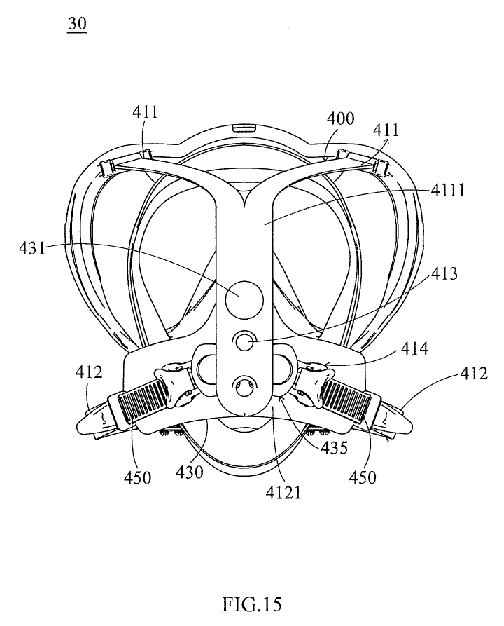

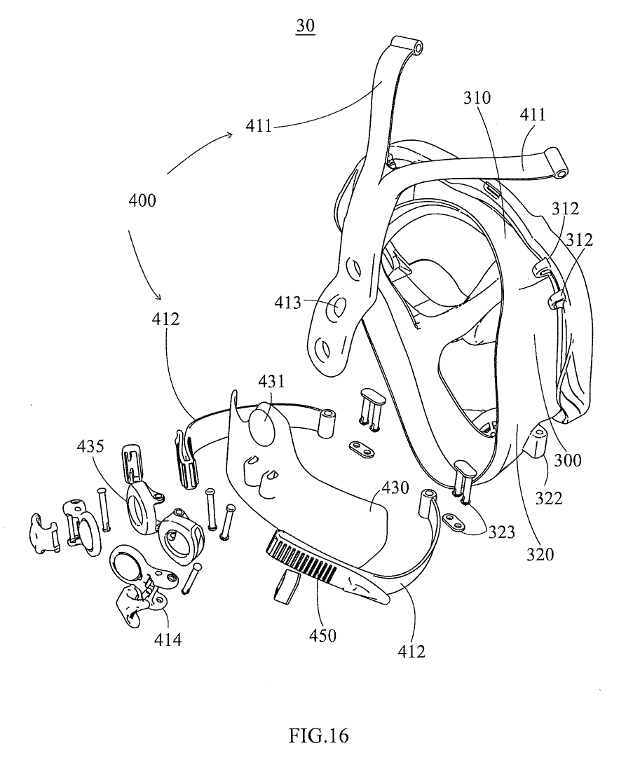

As shown in FIG. 14 and FIG. 15, the diving and snorkeling mask structure 30 of the third embodiment in the present invention mainly differs from the diving and snorkeling mask structure 20 of the second embodiment in that: the elastic head strap 400 of the diving and snorkeling mask structure 30 may have a soft material base 430, and the soft material base 430 is provided with a bump 431 and two quick release buckle bodies 435. Referring to FIG. 16 together, two upper ends 411 of the elastic head strap 400 together are formed into a Y shape, and tips 4111 of the upper ends 411 (i.e., tips distal from the mask) converge into a whole part that is provided with three holes 413 so that the user can select one among the holes 413 that fits the size of his/her head and engage the selected hole with the bump 431 on the soft material base 430. Tips 4121 of two lower ends 412 of the elastic head strap 400 (i.e., tips distal from the mask) are each provided with a quick release buckle 414 to snap fit the quick release buckle bodies 435 on the soft material base 430.

Additionally, each of the two lower ends 412 has a latch 450 through which the user can adjust the width of the elastic head strap 400.

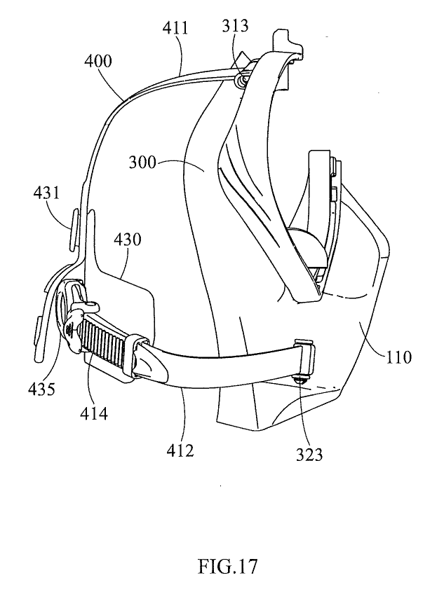

The elastic head strap 400 may also be joined to the full face mask 110 in other manners. For example, as shown in FIG. 16 and FIG. 17, two flange holes 312 may be disposed at each of two sides of an upper portion 310 of the external hard frame 300 such that the two upper ends 411 of the elastic head strap 400 are disposed between the two flange holes 312, and a supporting rod 313 passes through the two flange holes 312 and the two upper ends 411 so that the two upper ends 411 are joined to the two flange holes 312. A hole 322 is disposed at each of two sides of a lower portion 320 of the external hard frame 300, through which two connection buckles 323 respectively snap fit the two lower ends 412 of the elastic head strap 400, thereby securing the elastic head strap 400.

In this way, through the arrangement of the bump 431 and the quick release buckle 414, the user can arbitrarily adjust the tightness of the elastic head strap 400 of this embodiment depending on actual needs, and the combination of the soft material base 430 and the elastic head strap 400 greatly improves the comfort level in use of the user.

Furthermore, adjusting structures such as the latch 450, the quick release buckle 414 and the hole 413 are disposed at the back of the user's head, thereby making it more convenient to adjust the diving and snorkeling mask structure 30 to the size fitting the user's head.

Another additional advantage of providing the external hard frame 300 on the diving and snorkeling mask structures 20 and 30 in the present invention lies in that: an auxiliary device 500 can be hung on the external hard frame 300.

For example, a goggle mask currently available on the market is only provided with a hard material region above the mask, so in order to satisfy special needs such as performing underwater photography, a mechanism will be installed above the mask and near the forehead of the user so that a miniature video camera is fixed thereto. However, because the location where the miniature video camera is disposed is not within the field of vision of the user, the operation thereof is not easy.

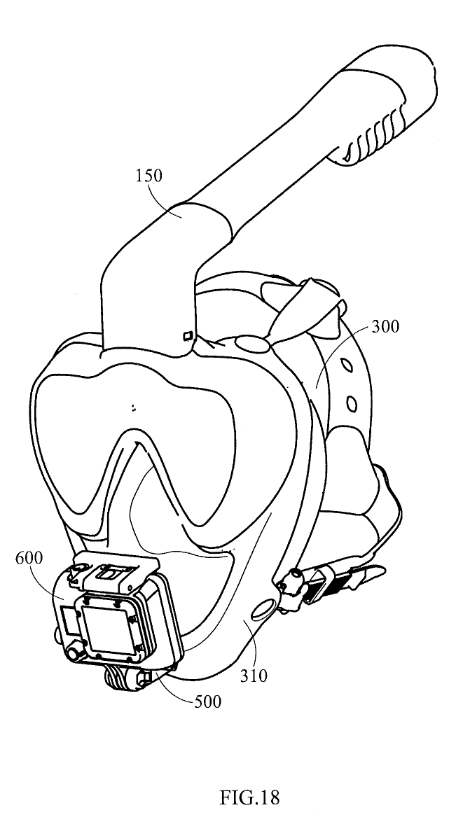

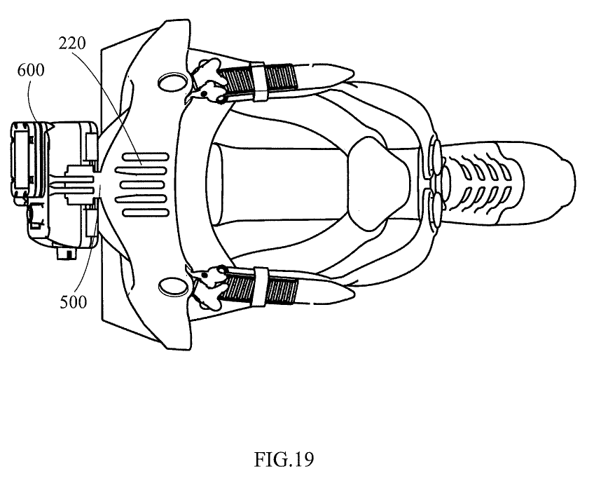

Referring to FIG. 18 and FIG. 19, the diving and snorkeling mask structures 20 or 30 of the present invention have an external hard frame 300, so an auxiliary device 500 (e.g., a fixing mechanism) may be additionally disposed at a lower portion 310 of the external hard frame 300 so that a miniature video camera 600 is installed on the auxiliary device 500. In this way, the miniature video camera 600 can be installed within the field of vision of the user, and meanwhile, the viewing angle of the user may be comparable with the range recorded by the miniature video camera 600, and it is convenient for the user to operate.

Through the aforesaid arrangement, the diving and snorkeling mask structures 10, 20 and 30 of the present invention can provide at least the following technical features:

1. except for the lens 130, the diving and snorkeling mask structure 10 is all made of soft materials, so the user can achieve ear pressure balance under the water by pinching his/her nose through the mask made of soft materials; and the use of the soft materials greatly reduces the weight of the diving and snorkeling mask structure 10, thereby providing the user with a goggle mask that is comfortable to wear and convenient to carry.

2. the periphery of the lens 130 of the diving and snorkeling mask structure 10 is made of soft materials, so the lens 130 can get closer to the user's face, thereby increasing the visible area of the viewing region 180 and providing the user with a broader filed of vision.

3. the special design of the latching device 210 can prevent the respiratory tube 150 from being bent due to the pressure during the diving; and the respiratory tube 150 can be directly bent for storage by means of the joint 140 in the form of a hose disposed between the respiratory tube 150 and the lens 130, thereby preventing the loss of the respiratory tube 150.

4. the arrangement of the water draining valve 220 and the top cover 230 can effectively drain the water from the mask to the outside.

5. the elastic head strap 400 may be disposed on the external hard frame 300 of the diving and snorkeling mask structures 20 and 30, thereby achieving the effect of stabilizing the full face mask 110.

6. the elastic head strap 400 is disposed in the form of a quick release buckle, thereby facilitating the putting on and the taking off of the diving and snorkeling mask structure.

7. the miniature video camera 600 may be disposed on the diving and snorkeling mask structures 20 and 30 by virtue of the special design of the external hard frame 300, thereby achieving the effect of recording at any time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A diving and snorkeling mask structure adapted to be worn on a user's head, comprising:
a full face mask, comprising a first soft material region and a second soft material region connected with each other;
a frame, combined with the second soft material region of the full face mask;
at least one lens, disposed in the frame;
a joint, disposed on the full face mask and adjacent to an upper side of the frame;
a respiratory tube, disposed on the joint and establishing the air communication with the full face mask via the joint; and
at least one securing belt, comprising a side buckle element adapted to snap fit the full face mask.

2. The diving and snorkeling mask structure according to claim 1, wherein the soft material of the first soft material region has a hardness smaller than that of the soft material of the second soft material region.

3. The diving and snorkeling mask structure according to claim 2, wherein a total area of the first soft material region and the second soft material region is larger than a half of a viewing window area of the at least one lens.

4. The diving and snorkeling mask structure according to claim 1, wherein the first soft material region and the second soft material region are of a same material.

5. The diving and snorkeling mask structure according to claim 1, further comprising a water draining valve disposed at a lower end of the full face mask and adjacent to the user's mouth.

6. The diving and snorkeling mask structure according to claim 1, further comprising a latching device, wherein the latching device has a connection element as well as a latch and a groove engaged with each other, the connection element is adapted to make the respiratory tube bendable with respect to the frame, and the latch and the groove are disposed on the joint and the frame respectively.

7. The diving and snorkeling mask structure according to claim 1, further comprising an external hard frame disposed around the full face mask.

8. The diving and snorkeling mask structure according to claim 7, wherein at least one elastic head strap is disposed on the external hard frame.

9. The diving and snorkeling mask structure according to claim 7, wherein an auxiliary device is disposed at a lower portion of the external hard frame to fix a miniature video camera.

10. The diving and snorkeling mask structure according to claim 1, wherein the side buckle element snap fits the full face mask in the form of a quick-release buckle.

11. The diving and snorkeling mask structure according to claim 1, wherein the at least one securing belt has a plurality of latches for adjusting the length of the at least one securing belt.

12. The diving and snorkeling mask structure according to claim 1, wherein the respiratory tube further comprises a top cover and a seal ring, the top cover is movably disposed at an end of the respiratory tube, the seal ring is disposed around a periphery of the end, and the top cover has a protrusion so that, when the top cover moves upwards relate to the respiratory tube, the protrusion abuts against the seal ring.
